(19) United States
(12) Patent Application Publication
(10) Pub. No.: US 2016/0270194 A1
(43) Pub. Date: Sep. 15, 2016

(54) ATTACHABLE LIGHTING CONTROL APPARATUS

(71) Applicant: PHILIPS LIGHTING HOLDING B.V., Eindhoven (NL)

(72) Inventors: PHILIP STEVEN NEWTON, WAALRE (NL); RAMON ANTOINE WIRO CLOUT, EINDHOVEN (NL); BARTEL MARINUS VAN DE SLUIS, EINDHOVEN (NL)

(73) Assignee: PHILIPS LIGHTING HOLDING B.V., Eindhoven (NL)

(21) Appl. No.: 15/028,153

(22) PCT Filed: Oct. 16, 2014
(86) PCT No.: PCT/IB2014/065351

§ 371 Date: Apr. 8, 2016

Related U.S. Application Data
(60) Provisional application No. 61/894,935, filed on Oct. 24, 2013.

(51) Int. Cl. H05B 37/02; F21V 23/04; H05B 33/08

(52) U.S. Cl. CPC H05B 37/0272; H05B 33/0845; F21V 23/0485

(57) ABSTRACT

Disclosed is an attachable apparatus (100) and related methods for controlling one or more properties of light emitted by a light source. In various embodiments, the attachable lighting control apparatus may be secured to a surface (632), which in some instances may be on or near the light source (630). In various embodiments, a placement sensor (218) may detect that the attachable lighting control apparatus has been secured to the surface, and may activate the attachable lighting control apparatus. Activation may cause the attachable lighting control apparatus to, automatically or in response to one or more additional events, commission itself to control one or more properties of light emitted by the light source. In various embodiments, the attachable lighting control apparatus may generate and transmit to the light source a lighting instruction based on touch input received at one or more touch-sensitive sensors (216) of the attachable lighting control apparatus.

### TECHNICAL FIELD

The present invention is directed generally to lighting control. More particularly, various inventive methods and apparatus disclosed herein relate to installation and/or use of an attachable lighting control device to control one or more properties of light emitted by a nearby light source.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects.

Various control devices exist for controlling properties of light emitted from a light source. Some such control devices have touch-sensitive user interfaces that enable a user to alter one or more properties of light emitted by a light source based on a location touched on the touch-sensitive user interface. Some such control devices may include mounting hardware to facilitate mounting the control devices to walls, e.g., using screws and other fasteners, so that the control device may be readily located when control of the light source is desired. Some light sources may include a docking station (e.g., mounted to the light source or to a wall nearby). When a control device is docked in the docking station, it communicates with the light source via circuitry in the docketing station. When the control device is removed from the docking station, it may communicate with the light source using other methods of communication, such as wireless communication. Other control devices may include wired connection mechanisms, such as RJ45 connectors, to communicate with a light source. Many control devices are relatively bulky (e.g., due to inclusion of batteries or other power sources), cumbersome to install, and/or tricky to configure for use with a particular light source. Mobile computing devices, such as smart phones and tablets, may also be used to control one or more properties of light emitted by a light source. However, such devices may not always be available or readily located when lighting control is desired.

Thus, there is a need in the art for lighting control apparatus that are simple to install and configured for use to control one or more light sources. There is also need for lighting control apparatus that are small and have low profiles when installed, so that they can unobtrusively be installed on or near a light source, and easily located when needed.

### SUMMARY

The present disclosure is directed to inventive methods and apparatus for lighting control. A lighting control apparatus as described herein may be small, have a low profile when installed, be simple to commission for use to control a light source, and may be self-powered.

Generally, in one aspect, an attachable lighting control apparatus may include one or more touch pads, a placement sensor to detect that the attachable lighting control apparatus is secured to a surface on or near the light source, a microcontroller configured to generate, based on touch input received at the one or more touch pads, a lighting instruction to cause the light source to emit light having one or more lighting properties, and a communication interface configured to wirelessly transmit the lighting instruction to the light source. In various embodiments, such an apparatus may be commissioned for control of the light source, and, once commissioned, usable to control one or more properties of light emitted by the light source.

In one aspect, an attachable lighting control apparatus may include one or more touch pads, such as, for example, capacitive touch pads, as well as a placement sensor to detect that the attachable lighting control apparatus is secured to a surface, and a microcontroller. The microcontroller may be configured to generate, based on touch input received at the one or more touch pads, a lighting instruction to cause the light source to emit light having one or more lighting properties. The attachable lighting control apparatus may further include a communication interface configured to wirelessly transmit the lighting instruction to the light source.

In various embodiments, the attachable lighting control apparatus may include a battery to power the one or more touch pads, the microcontroller and the communication interface. In various versions, the attachable lighting control apparatus may further include a photovoltaic cell to recharge the battery. In various versions, the battery may be an at least partially transparent lithium ion battery.

In various embodiments, the attachable lighting control apparatus may include adhesive material to create an adhesive bond between the attachable lighting control apparatus and the surface. In various embodiments, the attachable lighting control apparatus may include a magnetic element to create a magnetic bond between the attachable lighting control apparatus and the surface. In various embodiments, the attachable lighting control apparatus may include a suction portion to create a suction-based bond between the attachable lighting control apparatus and the surface.

The microcontroller may be further configured to transition the attachable lighting control apparatus from a first state in which the attachable lighting control apparatus consumes a first amount of power to a second state in which the attachable lighting control apparatus consumes a second amount of power that is greater than the first amount of power, in response to detection by the placement sensor that the attachable lighting control apparatus is secured to a surface.

In various embodiments, the placement sensor includes two or more electrodes configured to detect a change in resistance associated with the attachable lighting control apparatus. In various versions, the attachable lighting control apparatus may include a peelable cover with a predetermined resistance, removal of which exposes an adhesive material applied to the attachable lighting control apparatus and causes the change in resistance.

In various versions, the placement sensor may include an accelerometer to detect an orientation of the attachable lighting control apparatus. The microcontroller may be configured to perform the transition in response to a determination, based on output of the accelerometer, that the attachable lighting control device has remained stable for greater than a predetermined time interval. In various versions, the microcontroller may be configured to perform the transition responsive to detection of user contact with the one or more touch pads. In various versions, the microcontroller may be further configured to transition the attachable lighting control apparatus from the second state back to the first state responsive to passage of a predetermined time interval without receiving touch input at the one or more touch pads.

In various embodiments, the attachable lighting control apparatus may include a commissioning module configured to establish two-way wireless communication with the light source. In various versions, the attachable lighting control apparatus may include a coded light sensor. The commissioning module may be configured to extract an identifier associated with the light source from a coded light signal received at the coded light sensor from the light source, and the microcontroller is configured to further base generation of the lighting instruction at least in part on the extracted identifier. In various versions, the attachable lighting control apparatus may include a peelable cover, removal of which exposes the coded light sensor.

In various embodiments, the one or more touch pads may comprise two or more concentric, ring-shaped touch pads. The microcontroller may be configured to generate the lighting instruction to cause the light source to emit light having first and second properties based on touch input received at first and second touch pads, respectively, of the two or more concentric, ring-shaped touch pads.

In another aspect, a method of commandeering and controlling a light source may include: securing an attachable lighting control apparatus to a surface on or near the light source; initiating commissioning of the attachable lighting control apparatus for wireless control of one or more properties of light emitted by the light source; and providing touch input at one or more touch-sensitive sensors of the attachable lighting control apparatus to cause the attachable lighting control apparatus to generate, based on the touch input, a lighting instruction for wireless transmission to the light source, the lighting instruction to cause the light source to emit light having one or more lighting properties.

In various embodiments, the method may further include exposing a photovoltaic cell to light from the light source to recharge a battery of the attachable lighting control apparatus. In various embodiments, the initiating may include the securing. In various embodiments, the initiating may include removing a cover, such as, for example, a peelable layer or film, from an adhesive surface of the attachable lighting control apparatus. In various embodiments, the securing may include creating suction between an adhesive surface of the attachable lighting control apparatus and the surface on or near the light source.

In various embodiments, the initiating may include changing a resistance between two or more electrodes of the attachable lighting control apparatus. In various versions, the initiating may include removing a peelable cover from the attachable lighting control apparatus to change the resistance between the two or more electrodes.

In various embodiments, the initiating may include exposing a coded light sensor of the attachable lighting control apparatus to a coded light signal emitted by the light source, to enable the attachable lighting control apparatus to extract an identifier associated with the light source from the coded light signal.

In another aspect, an attachable lighting control apparatus adapted to be secured to a surface on or near a light source may include: one or more touch-sensitive sensors; an adhesive surface to secure the attachable lighting control apparatus to the surface on or near the light source; a peelable cover that is removable to expose the adhesive surface and activate the attachable lighting control apparatus; a commissioning module to, on activation, establish two-way wireless communication with the light source; a microcontroller coupled to the one or more touch-sensitive sensors and configured to generate, based on touch input received at the one or more touch-sensitive sensors, a lighting instruction to cause the light source to emit light having one or more lighting properties; a communication interface coupled to the microcontroller and configured to wirelessly transmit the lighting instruction to the light source; a battery to power the one or more touch-sensitive sensors, the commissioning module, the microcontroller and the communication interface; and a photovoltaic cell to recharge the battery. In various embodiments, prior to its removal, the peelable cover may create a separation between the battery and the microcontroller, such that removal of the peelable cover removes the separation to cause activation of the attachable lighting control apparatus.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers).

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs.

The term “light source” should be understood to refer to any one or more of a variety of radiation sources, including, but not limited to, LED-based sources (including one or more LEDs as defined above). A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The terms “lighting fixture” and “luminaire” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically illustrates an example attachable lighting control apparatus, in accordance with various embodiments.

FIG. 2 schematically illustrates components of an example attachable lighting control apparatus, in accordance with various embodiments.

FIG. 3 schematically depicts shapes of example attachable lighting control apparatus, in accordance with various embodiments.

FIGS. 4-5 schematically depict example arrangements of capacitive touch pads that may be employed in attachable lighting control apparatus, in accordance with various embodiments.

FIG. 6 depicts an example light source with an attachable lighting control apparatus installed nearby, in accordance with various embodiments.

FIG. 7 depicts an example method of installing and using an attachable lighting control apparatus, in accordance with various embodiments.

### DETAILED DESCRIPTION

Lighting control devices exist that facilitate control of one or more properties of light emitted by a light source. However, many of these devices are bulky, cumbersome to install and/or difficult to configure for control of a particular light source. Accordingly, Applicants have recognized and appreciated that it would be beneficial to provide lighting control apparatus that are small and/or have a low profile when installed. They also recognized that it would be beneficial to provide lighting control apparatus that are simple to install and easily and intuitively commissioned for use with a particular light source, as well as easy to find when needed. In view of the foregoing, various embodiments and implementations of the present invention are directed to lighting control apparatus that are small, have low profiles, are easy to install and intuitive to commission for use to control illumination of a particular light source.

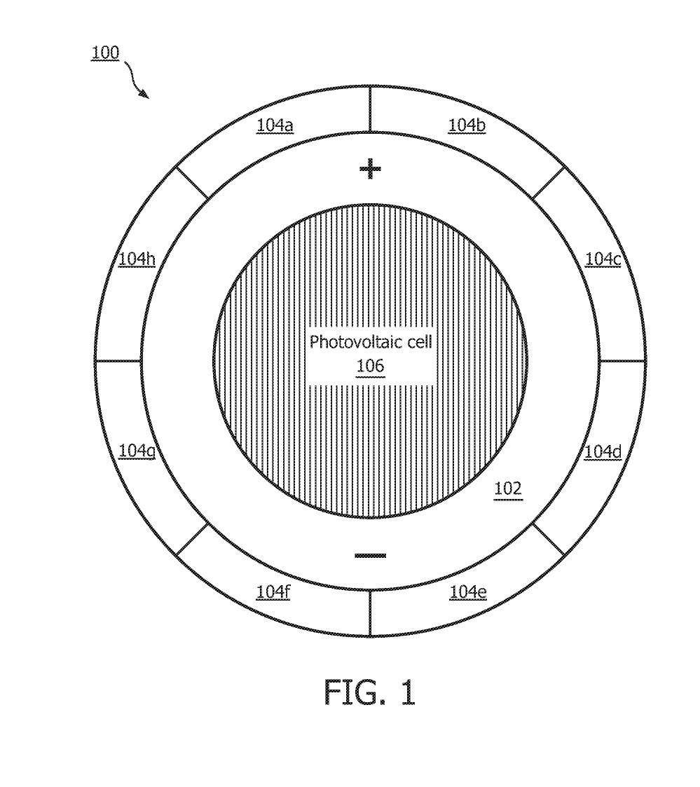

Referring to FIG. 1, in one embodiment, an attachable lighting control apparatus 100 may include one or more touch-sensitive sensors, which in FIG. 1 are depicted as concentric, ring-shaped capacitive touch pads 102 and 104. However, other types of touch-sensitive sensors known in art can also be used. Attachable lighting control apparatus 100 may be configured to generate, e.g., based on touch input (also referred to as “touch input”) received at capacitive touch pads 102 and 104, a lighting instruction to cause a light source (not depicted in FIG. 1) to emit light having one or more selected lighting properties. As will be described in more detail below, attachable lighting apparatus 100 may be secured to a surface on or near the light source so that it may be easily located, and may wirelessly transmit the generated lighting instruction to the light source.

In some embodiments, attachable lighting control apparatus 100 may be preprogrammed, e.g., by the manufacturer, to control one or more properties of light emitted by a particular light source. In such cases, each attachable lighting control apparatus 100 may be “dedicated” to a particular light source at the outset. In other embodiments, and as will be described below, attachable lighting control apparatus 100 may be commissioned to control light output of the light source. In some such embodiments, it may be possible to “recommission” attachable lighting control apparatus 100 for a different light source; in other cases, once commissioned, attachable lighting control apparatus 100 may thereafter be dedicated to its assigned light source.

In various embodiments, capacitive touch pad 102 may be operated by a user to control a first property of light emitted by a light source. Properties of emitted light that may be controlled using capacitive touch pad 102 and other touch-sensitive sensors described herein may include any property of emitted light, including but not limited to brightness, hue, saturation, temperature, intensity, animation, coded light, and so forth.

Capacitive touch pad 102 may be operated in various ways. For instance, a user may trace her finger along capacitive touch pad 102 in a clockwise direction to increase brightness of light emitted by a light source. Likewise, the user may trace her finger along capacitive touch pad 102 in a counter clockwise direction to decrease brightness of light emitted by the light source. In FIG. 1, capacitive touch pad 102 includes “+” and “−” symbols. As an alternative to tracing the ring shape, a user may press those symbols to increase or decrease the level of the lighting property by a predetermined amount. The user may also press and hold on those symbols to affect a gradual increase/decrease of brightness.

Capacitive touch pad 104 may be operated by a user to control a second property of light emitted by the light source. Similar to capacitive touch pad 102, a user may trace her finger along capacitive touch pad 104 in various directions, e.g., clockwise and counterclockwise, to toggle between various potential states of the second property of light emitted by the light source. Unlike a lighting property such as brightness, which has a level that can simply be turned up or down, the second light property may have multiple discrete potential states, such as various hues or colors. Thus, for instance, in FIG. 1, capacitive touch pad 104 includes multiple areas 104a-h. Each of these areas may correspond to a color or a range of colors within the color spectrum. Although the boundaries between areas 104a-h are well-defined in FIG. 1, this is not meant to be limiting. In various embodiments, the boundaries between areas 104a-h may be less defined. For example, capacitive touch pad 104 may be colored, e.g., using stickers or using light sources built into attachable lighting control apparatus 100, to track colors of the rainbow, with transitions between colors occurring gradually along a gradient. For instance, 104c may represent a range of blue colors, 104d may represent a range of purple colors, and 104e may represent a range of red colors. Other arrangements of colors obviously are possible.

Lighting control apparatus 100 may be powered in various ways. In some embodiments, lighting control apparatus 100 may include a battery (not shown in FIG. 1) that may be recharged, e.g., by way of a photovoltaic cell 106 configured to receive light and convert it to energy. In various embodiments, the battery may be relatively small and/or be relatively flat, so that when lighting control apparatus 100 is secured to a surface on or near a light source, it has a relatively low profile relative to the surface. For example, in various embodiments, the battery may be an at least partially transparent lithium ion battery, and/or a poly lithium button cell.

Attachable lighting control apparatus 100 may be secured to a surface on or near a light source in various ways. In some embodiments, attachable lighting control apparatus 100 may include adhesive material, such as glue, on a surface (e.g., a bottom surface opposite the surface visible in FIG. 1) to create an adhesive bond between attachable lighting control apparatus 100 and the surface on or near the light source. In some embodiments, until attachable lighting control apparatus 100 is secured to a surface, the adhesive material may be protected by a cover, e.g., with a peelable layer or film, to avoid accidentally securing lighting control apparatus 100 to another surface. As will be discussed below, in some embodiments, such a peelable cover may form a functional part of a placement sensor. For example, the peelable cover may include electrical properties that enable it to act as an actuator of attachable lighting control apparatus 100. In some such embodiments, when the peelable cover is removed, lighting control apparatus 100 may be activated and begin a process of automatically commissioning itself to control one or more properties of light emitted by a nearby light source. In other embodiments, lighting control apparatus 100 is commissioned during manufacturing, and may even be provided with a lamp/luminaire as a “kit.” Such a lighting control apparatus 100 may be placed by a user anywhere in her home. To keep manufacturing costs low, in some cases, lighting control apparatus 100 may be designed to be placed once, or placed and replaced a relatively small number of times (e.g., before the inexpensive adhesive becomes ineffective).

Attachable lighting control apparatus 100 may be secured to a surface using other means. For example, in some embodiments, attachable lighting control apparatus 100 may include a magnetic element, e.g., an internal magnet, to create a magnetic bond between attachable lighting control apparatus 100 and the surface on or near the light source. This may enable attachable lighting control apparatus 100 to be removable from the surface and repositioned elsewhere, e.g., near the same light source or near a new light source.

In some embodiments, attachable lighting control apparatus 100 may include a suction portion shaped into the bottom surface. The suction portion may create a suction-based bond between attachable lighting control apparatus 100 and the surface on or near the light source. Like magnetized embodiments, a suction-based embodiment may be removable, and hence, repositionable elsewhere.

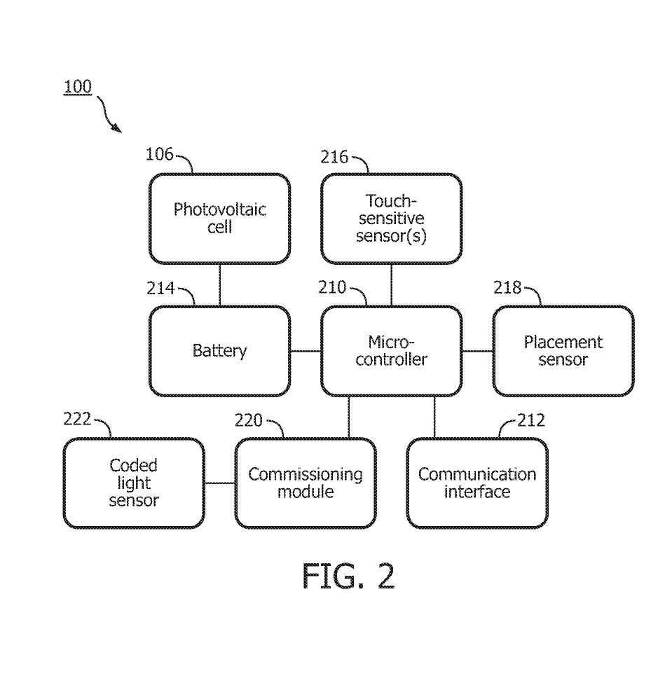

FIG. 2 depicts example components of lighting control apparatus 100. In various embodiments, lighting control apparatus 100 may be controlled at least in part by a microcontroller 210. Microcontroller 210 may come in various forms, and may include various components that are not depicted in FIG. 2, including but not limited to embedded RAM, Flash storage, etc. In some embodiments, microcontroller 210 may be implemented using hardware such as (but not limited to) the JN5147-001 wireless controller by NXP Semiconductors, N.V.

In various embodiments, microcontroller 210 may be operably coupled to a communication interface 212. In various embodiments, communication interface 212 may include one or more antenna or other communication mechanisms, and may be configured to wirelessly transmit a lighting instruction generated by microcontroller 210 to a light source (not depicted in FIG. 2). Communication interface 212 may transmit and/or receive data to/from light sources or other remote devices using various technologies. In some embodiments, communication interface 212 may transmit data to a light source using a low power wireless communication technology, such as z-wave and/or ZigBee, or even coded light, near field communication (NFC) and radio frequency identification (RFID) where attachable lighting control apparatus is to be placed relatively close to (e.g., within centimeters) its corresponding lamp/luminaire.

As noted above, attachable lighting control apparatus 100 may include a battery 214 to power various components, such as capacitive touch pads 102 and 104 in FIG. 1, microcontroller 210, communication interface 212, and so forth. In various embodiments, battery 214 may be small enough to cause lighting control apparatus 100 to have a relatively low profile when secured to a surface on or near a light source. As noted above, in various embodiments, battery 214 may be an at least partially transparent lithium ion battery. As noted above, in various embodiments, lighting control apparatus 100 may be equipped with a photovoltaic cell 106 or other similar means for recharging battery 214.

Attachable lighting control apparatus 100 may also include one or more touch-sensitive sensors 216, such as capacitive touch pads 102 and 104 of FIG. 1. Touch-sensitive sensors 216 may be implemented using various technologies, including but not limited to capacitive touch pads as shown in FIG. 1, resistive touch pads, and so forth. In some embodiments, touch-sensitive sensors 216 may be implemented using a separate capacitive sensing module, such as the PCF8885TS capacitive 8-channel proximity switch with low power consumption by NXP Semiconductors, N.V.

To keep a profile of attachable lighting control apparatus 100 relatively small, battery 214 (and other components) may be small, and thus may not be capable of storing a significant amount of power. Accordingly, attachable lighting control apparatus 100 may operate in various states in order to, among other things, conserve power. For example, in various embodiments, microcontroller 210 may be configured to transition attachable lighting control apparatus 100 between various states in response to various events in order to accomplish various tasks while conserving power.

For example, in some embodiments, microcontroller 210 may be configured to transition attachable lighting control apparatus 100 from a first state, e.g., an inactive state in which attachable lighting control apparatus 100 consumes little-to-no power, to a second state, e.g., an active state in which attachable lighting control apparatus 100 consumes a greater amount of power. In various embodiments, while in the inactive state, microcontroller 210, communication interface 212 and other components may consume very little power, such as in the range of micro Amps. In various embodiments, while in the active state, the current used may increase to tens of milliamps. These small amounts of current may enable attachable lighting control apparatus 100 to have a very small battery 214.

In some embodiments, while in its active state, attachable lighting control apparatus 100 may perform various actions to attempt to commission itself for control of a nearby light source. For example, attachable lighting control apparatus 100 may periodically broadcast, e.g., via communication interface 212, one or more signals configured to be detected and/or responded to by “listening” light sources nearby. When it receives response signals from multiple light sources, microcontroller 210 may determine the strongest response signal, and may attempt to commandeer control of that light source.

In various embodiments, microcontroller 210 may initiate the transition from the inactive state to the active state in response to various events, such as a determination that attachable lighting control apparatus 100 has been secured to a surface on or near a light source-to-be-controlled.

To this end, in various embodiments, attachable lighting control apparatus 100 may include a placement sensor 218. Placement sensor 218 may include a variety of electrical and physical components that together may facilitate detection that attachable lighting control apparatus 100 has been secured to a surface on or near the light source. For example, in some embodiments, placement sensor 218 may include two or more electrodes (not depicted) that are configured to detect a change in resistance associated with attachable lighting control apparatus 100. In some embodiments, the peelable cover mentioned above may have its own predetermined resistance, such that its removal causes a change in resistance that is detected by the two or more electrodes of placement sensor 218. In other embodiments, removal of the adhesive removes a piece of plastic between the battery and the electronics, which may cause attachable lighting control apparatus 100 to begin commissioning, or if already commissioned (e.g., by the manufacturer), to begin working to be usable to control light emitted by the corresponding commissioned light source.

In some embodiments, in addition to or instead of a peelable cover with resistance, placement sensor 218 may include an accelerometer and/or a gyroscope to detect an orientation of the attachable lighting control apparatus 100. In some cases it may be assumed that once attachable lighting control apparatus 100 has been stationary for enough time, e.g., as determined from output of the accelerometer being stable, attachable lighting control apparatus 100 has been secured to a surface on or near a light source. Accordingly, microcontroller 210 may be configured to determine, based on output of the accelerometer or gyroscope, that attachable lighting control apparatus 100 has remained stable for greater than a predetermined time interval (e.g., three seconds, five seconds, five minutes, etc.), and to transition attachable lighting control apparatus 100 from its inactive state to its active state.

In some embodiments, attachable lighting control apparatus 100 may include additional states. For instance, attachable lighting control apparatus 100 may consume even more power than the inactive or active states when it is in a third, “operating” state. Microcontroller 210 may transition attachable lighting control apparatus 100 to the operating state in response to various events. In some embodiments, microcontroller 210 may transition attachable lighting control apparatus 100 into the operating state in response to detecting touch input received at one or more touch-sensitive sensors 216, e.g., by way of a hardware interrupt.

While attachable lighting control apparatus 100 is in the operating state, microcontroller 210 may perform various tasks, such as generating a lighting control instruction based on touch input receive at one or more touch-sensitive sensors 216 and providing the lighting control instruction to communication interface 212. Likewise, while attachable lighting control apparatus 100 is in the operating state, communication interface 212 may be configured to transmit and/or receive data such as lighting instructions, e.g., to/from light sources.

As another energy-conservation measure, in various embodiments, microcontroller 210 may transition attachable lighting control apparatus 100 from the operating state back to the active or idle state, or from the active state back to the idle state, responsive to passage of a predetermined time interval without receiving touch input at touch-sensitive sensors 216.

In various embodiments, attachable lighting control apparatus 100 may include a commissioning module 220. Commissioning module 220 may be implemented with any combination of hardware and software (e.g., executed by microcontroller 210). In various embodiments, commissioning module 220 may be configured to commandeer control of one or more properties of light emitted by a nearby light source, e.g., by commissioning itself to control the light source. In some embodiments, for instance, commissioning module 220 may, e.g., by way of communication interface 212, establish two-way wireless communication with a nearby light source.

Commissioning module 220 may commission attachable lighting control apparatus 100 to control a light source in response to various events. In some embodiments, commissioning module 220 may commission attachable lighting control apparatus 100 automatically in response to a determination by placement sensor 218 that attachable lighting control apparatus 100 has been secured to a surface on or near a light source. For instance, assume placement sensor 218 detects that a resistance between two electrodes of attachable lighting control apparatus 100 has changed, e.g., due to removal of a peelable cover. Microcontroller 210 may responsively cause commissioning module 220 to begin its process of wirelessly reaching out to nearby light sources and commandeering control of one or more properties of light emitted by one of them.

In some embodiments, commissioning module 220 may include a coded light sensor 222. Commissioning module 220 may be configured to extract an identifier associated with a nearby light source from a coded light signal received at coded light sensor 222 from the light source. Microcontroller 210 may be configured to further base generation of the lighting instruction at least in part on the extracted identifier. For instance, if a coded light signal received by coded light sensor 222 from the nearest light source indicates a light source identifier of “123456,” microcontroller 210 may incorporate this identifier into the lighting instruction it transmits, so that the appropriate light source may take action and other light sources may ignore the instruction should they detect it.

In some embodiments, removal of a peelable cover from attachable lighting control apparatus 100 may expose coded light sensor 222, enabling it to detect coded light signals within its line of sight. In some embodiments, exposure of coded light sensor 222, in addition to or instead of a change in resistance between electrodes, is what triggers commissioning module 220 to attempt to commandeer control of light output by a light source.

In some embodiments, commissioning module 220 may be initiated manually. For example, once attachable lighting control apparatus 100 is secured to a surface on or near a light source, a user may press on a portion of one or more touch-sensitive sensors 216 to cause microcontroller 210 to initiate a Zigbee “touchlink” procedure in which network parameters of attachable lighting control apparatus 100 are transferred to the light source. This may set up two-way communication between attachable lighting control apparatus 100 and the light source. In some embodiments, this touchlink procedure may be initiated when attachable lighting control apparatus 100 is brought within a predetermined distance of a light source, e.g., 20-50 cm (as may be detected by a time-of-flight element). In some embodiments, where communication interface 212 utilizes Zigbee, it may also be possible to control the light source through another device, such as a bridge. In some cases, this may require that network parameters of attachable lighting control apparatus 100 are transferred to the bridge, which may be done in a manner similar to when they are sent to a light source, e.g., through the aforementioned “touchlink” procedure.

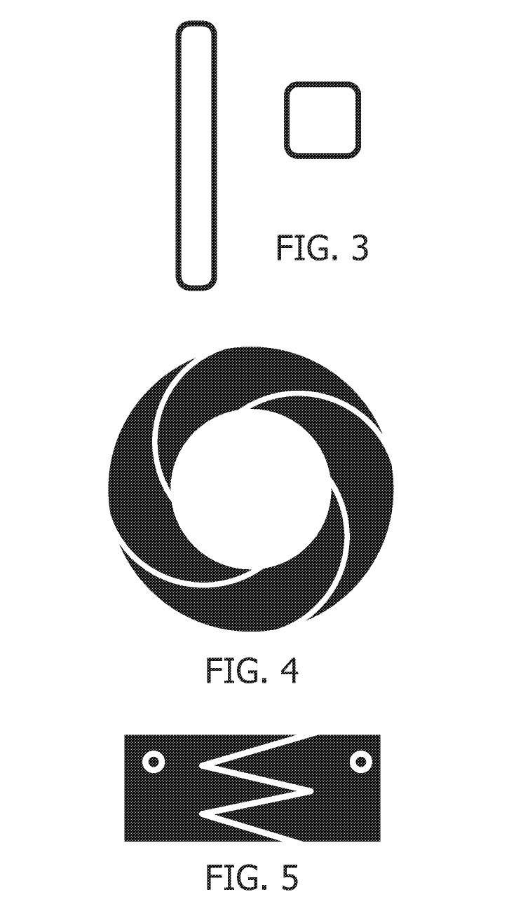

The example attachable lighting control apparatus 100 of FIG. 1 has a circular shape, but this is not meant to be limiting. In various embodiments, attachable lighting control apparatus 100, and, more particularly, its touch-sensitive sensors 216 (e.g., capacitive touch pads 102 and 104) may have any shape. FIG. 3 depicts two such examples. An attachable lighting control apparatus 100 and/or touch-sensitive sensor 216 in the elongate shape on the left may be usable to adjust a level of a light property up and down. For instance, sliding a finger down may adjust brightness down, whereas sliding a finger up may adjust brightness up. Additionally or alternatively, sliding a finger down may toggle through colors of the rainbow in one sequence, and sliding a finger up may toggle through the colors of the rainbow in an opposite sequence.

The other shape depicted in FIG. 3, a simple square shape, may be employed where only simple adjustments of light emitted by a light source are possible or desired. For instance, tapping a square-shaped attachable lighting control apparatus may turn a light source on or off. Pressing and holding a square-shaped attachable lighting control apparatus 100 may adjust a property of light emitted by the light source by an amount proportional to the amount of time the attachable lighting control apparatus 100 is pressed.

Regardless of the shape of attachable lighting control apparatus 100, in various embodiments, attachable lighting control apparatus 100 may store in memory (not shown) the most recent settings of one or more lighting properties of light emitted by a light source under its control. That way, if a user taps attachable lighting control apparatus 100 to turn off the light source, when it is later tapped to turn the light source back on, attachable lighting control apparatus 100 may generate and transmit to the light source a lighting instruction that causes the light source to restore the same lighting properties as before.

FIGS. 4-5 depict example configurations of capacitive touch pads that may be employed to achieve various light control capabilities. In FIG. 4, the capacitive touchpads are arranged in a generally circular pattern. Each separate pad may represent a different color or different range of colors, such that pressing a particular location within that capacitive touch pad will cause a corresponding color to be emitted. FIG. 5 depicts another example of how two separate capacitive touch pads may be arranged.

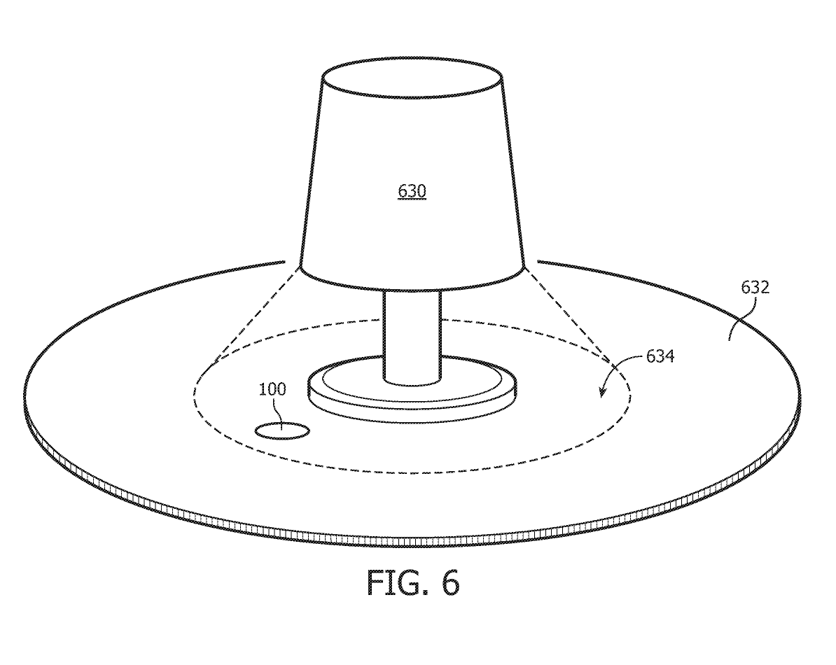

FIG. 6 depicts an example environment that includes a light source 630 in the form of a lamp sitting on a surface 632 such as a table top. This is for illustrative purposes only, and light sources as described herein may take various forms other than tabletop lamps, including other types of luminaires, wall or ceiling fixtures, ambient lighting devices, and so forth. In this example, light source 630 projects a lighting effect 634 onto surface 632. It should be understood that lighting effect 634 is not necessarily limited to this area, but may instead simply be strongest in this area (it may also pass through the depicted lampshade and out through the top of the lamp shade).

An attachable lighting control apparatus 100 has been secured to surface 632 within lighting effect 634. Placing attachable lighting control apparatus 100 within lighting effect 634, as opposed to outside of it, may have various advantages. For one thing, being within lighting effect 634 may ensure that attachable lighting control apparatus 100 is close enough to the light source to communicate wirelessly. For another thing, when light source 630 is illuminated, light it emits may be converted by photovoltaic cell 106 into energy for battery 214. Hence, while light source 630 is illuminated, attachable lighting control apparatus 100 may be kept in its operational mode, if desired, as it will continue to receive power from light emitted by light source 630. Additionally or alternatively, in some embodiments, attachable lighting control apparatus 100 may remain in its active state while light source 630 is illuminated, e.g., so that it can receive communications (e.g., in coded light) from light source 630, e.g., about various properties of light emitted by light source 630.

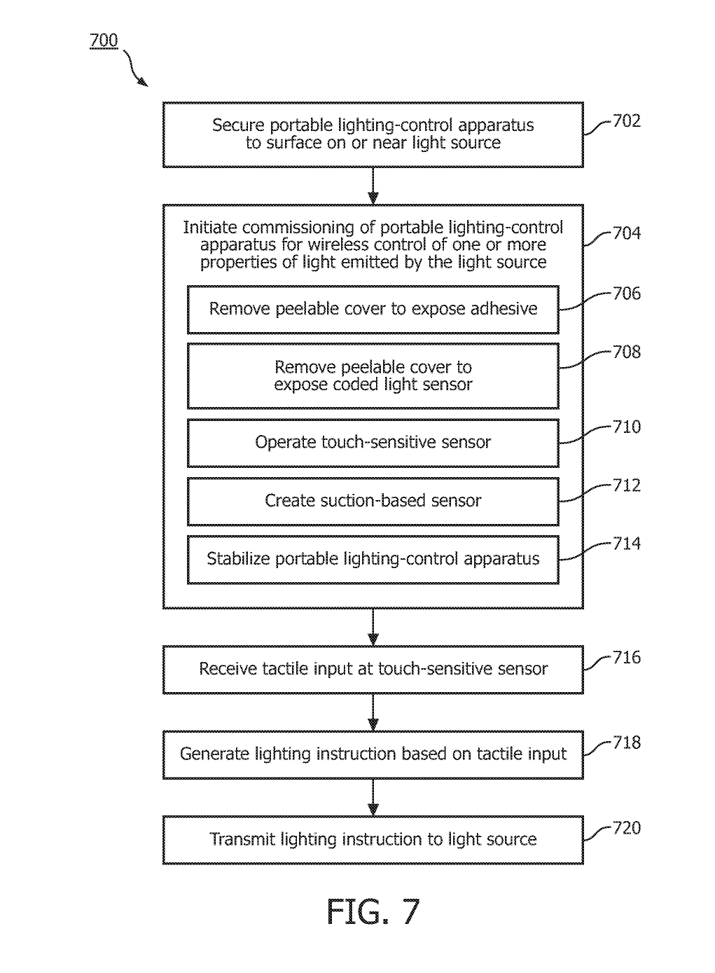

FIG. 7 depicts an example method 700 of installing and utilizing attachable lighting control apparatus 100 to control one or more properties of light emitted by a light source such as light source 630. At block 702, attachable lighting control apparatus 100 may be secured to a surface on or near a light source. In some embodiments, placement sensor 218 may detect placement and cause activation of attachable lighting control apparatus 100

At block 704, commissioning of attachable lighting control apparatus 100 for wireless control of one or more properties of light emitted by the light source may be initiated. In some embodiments, initiation of commissioning may occur contemporaneously with activation of attachable lighting control apparatus 100. In some embodiments, the initiation of commissioning at block 704 may occur automatically, e.g., in response to the securing of attachable lighting control apparatus 100 to the surface at block 702. For instance, placement sensor 218 may detect that attachable lighting control apparatus 100 has been secured to a surface on or near a light source, and may notify microcontroller 210 and/or commissioning module 220. In other embodiments, the initiation of block 704 may occur in response to another event that is related or unrelated to the securing and/or activation. For instance, in some embodiments, the initiation of commissioning at block 704 may occur in response to a peelable cover being removed to expose adhesive (block 706) or to expose a coded light sensor 222 (block 708).

In some embodiments, the initiation at block 704 may occur in response to operation by a user at block 710 of one or more touch-sensitive sensors 216. For example, after a user secures attachable lighting control apparatus 100 to the surface, she may press one or more capacitive touch pads (e.g., 102 or 104) to activate attachable lighting control apparatus 100. On activation, attachable lighting control apparatus 100, e.g., by way of microcontroller 210 and/or commissioning module 220, may commission itself to control one or more properties of light emitted by a light source.

In some embodiments, the initiation at block 704 may occur in response to creation, at block 712, of a suction-based bond between attachable lighting control apparatus 100 and the surface. For instance, attachable lighting control apparatus 100 may include a sensor such as a pressure or strain sensor configured to detect when suction has been created between attachable lighting control apparatus 100 and the surface.

In some embodiments, the initiation at block 704 may occur in response to stabilization, detected at block 714, of attachable lighting control apparatus 100, which may occur in response to attachable lighting control apparatus 100 being secured to the surface and remaining stable (e.g., as measured by an accelerometer) for at least a predetermined time interval.

As described above, the commissioning of attachable lighting control apparatus 100 may involve attachable lighting control apparatus 100 reaching out to nearby light sources and/or reading data broadcast by those light sources (e.g., as coded light signals), and in many cases establishing two-way communication with the closest light source. To determine which of multiple light sources it will control, attachable lighting control apparatus 100, e.g., by way of microcontroller 210, may compare incoming light source signals to determine which light source is closest. Attachable lighting control apparatus 100 may then commission itself to control that light source. For example, microcontroller 210 may store an identifier of the identified light source and may include the identifier (or other data indicative thereof) in outbound lighting instructions transmitted by attachable lighting control apparatus 100. That way, the closest light source may be responsive to the outbound lighting instruction, and other light sources may ignore it because it does not contain their identifiers. In some embodiment, as noted above, attachable lighting control apparatus 100 may initiate a ZigBee “touchlink” procedure with the light source-to-be-controlled.

At block 716, touch input may be received, e.g., at one or more touch-sensitive sensors 216 such as capacitive touch pads 102 and/or 104. At block 718, microcontroller 210 may generate a lighting instruction based on the touch input received at block 716 and/or light source-specific information obtained during commissioning. At block 720, microcontroller 210 may transmit, e.g., via communication interface 212, the generated lighting instruction to the light source-to-be-controlled. The light source may respond by adjusting one or more properties of light it emits in accordance with the lighting instruction.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Also, reference numerals appearing in the claims between parentheses are provided merely for convenience and should not be construed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An attachable lighting control apparatus, comprising:
one or more touch pads;
a placement sensor to detect that the attachable lighting control apparatus is secured to a surface;
a microcontroller configured to generate, based on touch input received at the one or more touch pads, a lighting instruction to cause the light source to emit light having one or more lighting properties; and
a communication interface configured to wirelessly transmit the lighting instruction to the light source,
wherein the microcontroller is further configured to transition the attachable lighting control apparatus from a first state in which the apparatus consumes a first amount of power to a second state in which the apparatus consumes a second amount of power that is greater than the first amount of power, in response to detection by the placement sensor that the apparatus is secured to a surface.

2. The attachable lighting control apparatus of claim 1, further comprising a battery to power the one or more touch pads, the microcontroller and the communication interface.

3. The attachable lighting control apparatus of claim 2, further comprising a photovoltaic cell to recharge the battery.

4. The attachable lighting control apparatus of claim 2, wherein the battery is an at least partially transparent lithium ion battery.

5. The attachable lighting control apparatus of claim 1, further comprising adhesive material to create an adhesive bond between the attachable lighting control apparatus and the surface.

6. The attachable lighting control apparatus of claim 1, further comprising a magnetic element to create a magnetic bond between the attachable lighting control apparatus and the surface.

7. The attachable lighting control apparatus of claim 1, further comprising a suction portion to create a suction-based bond between the attachable lighting control apparatus and the surface.

8. (canceled)

9. The attachable lighting control apparatus of claim 1, wherein the placement sensor comprises two or more electrodes configured to detect a change in resistance associated with the attachable lighting control apparatus.

10. (canceled)

11. The attachable lighting control apparatus of claim 1, wherein the placement sensor comprises an accelerometer to detect an orientation of the attachable lighting control apparatus, and the microcontroller is configured to perform the transition in response to a determination, based on output of the accelerometer, that the attachable lighting control device has remained stable for greater than a predetermined time interval.

12. The attachable lighting control apparatus of claim 1, wherein the microcontroller is configured to perform the transition responsive to detection of user contact with the one or more touch pads.

13. (canceled)

14. The attachable lighting control apparatus of claim 1, further comprising a commissioning module configured to establish two-way wireless communication with the light source.

15. The attachable lighting control apparatus of claim 14, further comprising a coded light sensor, wherein the commissioning module is configured to extract an identifier associated with the light source from a coded light signal received at the coded light sensor from the light source, and the microcontroller is configured to further base generation of the lighting instruction at least in part on the extracted identifier.

16. (canceled)

17. The attachable lighting control apparatus of claim 1, wherein the one or more touch pads comprise two or more concentric, ring-shaped touch pads, wherein the microcontroller is configured to generate the lighting instruction to cause the light source to emit light having first and second properties based on touch input received at first and second touch pads, respectively, of the two or more concentric, ring-shaped touch pads.

18. (canceled)

19. A method of commandeering and controlling a light source, comprising:
securing an attachable lighting control apparatus to a surface on or near the light source;
initiating commissioning of the attachable lighting control apparatus for wireless control of one or more properties of light emitted by the light source; and
providing touch input at one or more touch-sensitive sensors of the attachable lighting control apparatus to cause the attachable lighting control apparatus to generate, based on the touch input, a lighting instruction for wireless transmission to the light source, the lighting instruction to cause the light source to emit light having one or more lighting properties,
wherein the initiating comprises exposing a coded light sensor of the attachable lighting control apparatus to a coded light signal emitted by the light source, to enable the apparatus to extract an identifier associated with the light source from the coded light signal.

20. The method of claim 19, further comprising exposing a photovoltaic cell to light from the light source to recharge a battery of the attachable lighting control apparatus.

21. (canceled)

22. The method of claim 19, wherein the initiating comprises removing a peelable cover from an adhesive surface of the attachable lighting control apparatus.

23. The method of claim 19, wherein the securing comprises creating suction between an adhesive surface of the attachable lighting control apparatus and the surface on or near the light source.

24. The method of claim 19, wherein the initiating comprises changing a resistance between two or more electrodes of the attachable lighting control apparatus.

25. (canceled)

26. (canceled)

27. An attachable lighting control apparatus adapted to be secured to a surface on or near a light source, comprising:
one or more touch-sensitive sensors;
an adhesive surface to secure the attachable lighting control apparatus to the surface on or near the light source;
a peelable cover that is removable to expose the adhesive surface and activate the attachable lighting control apparatus;
a commissioning module to, on activation, establish two-way wireless communication with the light source;
a microcontroller coupled to the one or more touch-sensitive sensors and configured to generate, based on touch input received at the one or more touch-sensitive sensors, a lighting instruction to cause the light source to emit light having one or more lighting properties;
a communication interface coupled to the microcontroller and configured to wirelessly transmit the lighting instruction to the light source;
a battery to power the one or more touch-sensitive sensors, the commissioning module, the microcontroller and the communication interface; and
a photovoltaic cell to recharge the battery.

28. The attachable lighting control apparatus of claim 27, wherein prior to its removal, the peelable cover creates a separation between the battery and the microcontroller, such that removal of the peelable cover removes the separation to cause activation of the attachable lighting control apparatus.
